(19) United States
(12) Patent Application Publication
(10) Pub. No.: US 2015/0140903 A1
(43) Pub. Date: May 21, 2015

(54) METHODS FOR IMPARTING AN IMAGE TO A SURFACE AND KITS FOR USE THEREWITH

(71) Applicant: 3M INNOVATIVE PROPERTIES COMPANY, St. Paul, MN (US)

(72) Inventors: Jeffrey R. Janssen, Hernando, FL (US); Paul D. Graham, Woodbury, MN (US)

(21) Appl. No.: 14/608,872

(22) Filed: Jan. 29, 2015

Related U.S. Application Data
(62) Division of application No. 13/885,842, filed on May 16, 2013, now abandoned.
(60) Provisional application No. 61/415,274, filed on Nov. 18, 2010.

(51) Int. Cl. B44C 1/22

(52) U.S. Cl. CPC B44C 1/22
USPC 451/29

(57) ABSTRACT

A method for decorating a motor vehicle is disclosed comprising applying a mask to a painted exterior surface on the motor vehicle, the mask having a masked portion and an open portion that leaves part of the clearcoat layer exposed, wherein the masked portion and the open portion cooperate to define the image that is to be imparted to the surface, and wherein, prior to abrading the exposed part of the clearcoat layer, the exposed part of the clearcoat layer is free of defects. The exposed part of the clearcoat layer to is abraded to provide the exposed part of the clearcoat layer with a matte finish. The mask is removed to reveal an image having a matte finish region and an unabraded region.

### CROSS REFERENCE TO RELATED APPLICATIONS

This application is a divisional of U.S. application Ser. No. 13/885,842, filed May 16, 2013, now pending, which is a national stage filing under 35 U.S.C. 371 of PCT/US2011/060108, filed Nov. 10, 2011, which claims priority to U.S. Provisional Application No. 61/415,274, filed Nov. 18, 2010, the disclosures of which are incorporated by reference in their entireties herein.

### BACKGROUND

There are many situations where it may be desirable to impart an image to a surface. For example, the owner of a motor vehicle may wish to provide the vehicle's exterior surface with a logo, an aesthetic design, an advertisement, a message or other information. Techniques for imparting images to the exterior painted surface of a motor vehicle include applying an adhesive-backed vinyl decal or film, wrapping the vehicle in a printed or textured skin, and custom painting the vehicle. For glass, bare metal, and other surfaces it may be possible to sandblast or chemically etch the surface in order to impart an image thereto.

Each of these techniques, while useful, suffers from certain inherent limitations. For example, applied decals or films may not be durable, may fade with time, or may not be able to withstand repeated washing of the vehicle or wide fluctuations in temperature. Removing the decal or film could damage the underlying surface. Vehicle wrapping is intended to impart an image to a large portion of the vehicle surface and is less suited to decorating a small area. Custom painting is expensive and is best done by a skilled professional and so may be inconvenient for ordinary consumers to carry out by themselves.

The foregoing techniques provide an image that is essentially in the same plane as the rest of the vehicle surface rather than an image that is recessed relative to the surrounding surface on the vehicle. Sandblasting, chemical etching, and other erosive techniques may be capable of generating a recessed image, but they can be difficult to perform and have limited application because they aggressively alter the surface to which they are applied.

### SUMMARY

In one embodiment a kit for imparting an image to a painted exterior surface on a motor vehicle is provided. The kit comprises a mask that is adapted to be removably attached to an outer clearcoat layer of the painted exterior surface on the motor vehicle, the mask having a masked portion and an open portion that cooperate to define the image that is to be imparted to the surface, an abrasive that is capable of removing a portion of the outer clearcoat layer to generate an image having a matte finish region and an unabraded region, and one or more materials that may be used to provide the outer clearcoat layer in the matte finish region of the image with a surface gloss appearance that is consistent with the surface gloss appearance of the clearcoat layer in the unabraded region of the image.

In another aspect, a method for imparting an image to a painted exterior surface on a motor vehicle is provided. The method comprises applying a mask to an outer clearcoat layer of the painted exterior surface, the mask having a masked portion that covers part of the clearcoat layer and an open portion that leaves part of the clear coat layer exposed, wherein the masked portion and the open portion cooperate to define the image that is to be imparted to the surface, abrading the exposed part of the clearcoat layer to provide it with a matte finish, and removing the mask to reveal the image having a matte finish region and an unabraded region. The clearcoat layer in the matte finish region of the image is capable of being provided with a surface gloss appearance that is consistent with the surface gloss appearance of the clearcoat layer in the unabraded region of the image and without painting the surface of the motor vehicle.

In some embodiments, there is a smooth transition between the matte finish region of the image and the unabraded region of the image. In other embodiments, the matte finish region of the image is recessed relative to the unabraded region of the image.

In some embodiments, the clearcoat layer in the matte finish region of the image is treated to provide it with a surface gloss appearance that is consistent with the surface gloss appearance of the clearcoat layer in the unabraded region of the image and without painting the surface of the motor vehicle. In some embodiments, after the clearcoat layer in the matte finish region of the image has been treated, the unaided human eye may not discern an outline of the previously imparted image. In other embodiments, after the clearcoat layer in the matte finish region of the image has been treated, the image may have a recessed region and a raised region. In some embodiments, after the clearcoat layer in the matte finish region of the image has been treated the, one or more of the following may be noted: the clearcoat layer may be glossy; the unaided human eye may be unable to detect scratches in the clearcoat layer; or the clearcoat layer may display an orange peel texture.

### BRIEF DESCRIPTION OF THE DRAWINGS

The detailed description may be more fully appreciated by referring to the following non-limiting drawings in which:

FIG. 1 is top plan view of one embodiment of a mask that may be used to impart an image to a surface and wherein a pre-mask has been partially cut away to more clearly illustrate the underlying structure;

FIG. 2 is a sectional view taken along lines 2-2 in FIG. 1;

FIG. 3 is top plan view of another embodiment of a mask that may be used to impart an image to a surface and wherein a pre-mask has been partially cut away to more clearly illustrate the underlying structure;

FIG. 4 is a sectional view taken along lines 4-4 in FIG. 3;

FIG. 5A is a fragmentary, schematic, top plan view of an image imparted to a surface according to a first method described herein and employing the mask of FIGS. 1 and 2;

FIG. 5B is a fragmentary, schematic, top plan view of an image imparted to a surface according to a first method described herein and employing the mask of FIGS. 3 and 4;

FIG. 6A is a fragmentary, schematic, perspective view of an image imparted to a surface according to a second method described herein and employing the mask of FIGS. 1 and 2;

FIG. 6B is a fragmentary, schematic, perspective view of an image imparted to a surface according to a second method described herein and employing the mask of FIGS. 3 and 4;

FIG. 7 is a sectional view of a portion of one embodiment of an abrasive that may be used to impart an image to a surface as described herein;

FIG. 8 is a sectional view of a portion of another embodiment of an abrasive that may be used to impart an image to a surface as described herein; and

FIG. 9 is a sectional view of a portion of a further embodiment of an abrasive that may be used to impart an image to a surface as described herein.

### DETAILED DESCRIPTION

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Moreover, “a,” “an,” “the,” “at least one,” and “one or more” are used interchangeably. “At least one” includes all numbers of one and greater (e.g., at least 2, at least 4, at least 6, at least 8, at least 10, at least 25, at least 50, at least 100, etc.). Reciting ranges by endpoints includes the endpoints and all numbers subsumed within the range (e.g., 1 to 10 includes 1, 1.4, 1.9, 2.33, 5.75, 9.98, 10, etc.). Further, the term “and/or” means one or all of the listed elements or a combination of any two or more of the listed elements. The term “comprises” and variations thereof do not have a limiting meaning where these terms appear in the accompanying description.

This invention relates broadly to methods for imparting an image to a surface and kits for use with those methods. In one embodiment, the invention provides methods for imparting an image to a painted surface on a motor vehicle (for example, an automobile, truck, motorcycle, etc.), and kits that may be used to perform those methods.

The methods and kits described herein have particular utility for imparting images to painted exterior surfaces found in motor vehicles. Typically, these surfaces include a metal or plastic panel that has a primer coat, a colored or pigmented base layer over the primer coat, and an overlying, outer, protective clearcoat (i.e., non-pigmented or slightly pigmented) layer or topcoat layer. Generally this is referred to as a basecoat/topcoat or basecoat/clearcoat finish.

Conventional protective clearcoat layers are formulated with acrylic, urethane, or urethane-acrylic resins, which optionally may be modified by including ceramic particles having a size of less than about 100 nanometers to improve the hardness and scratch resistance of the clearcoat.

In some embodiments, a paint protection film, for example a clear (i.e., non-pigmented or slightly pigmented) urethane film having a thickness of about 150 μm to about 300 μm, with a pressure-sensitive adhesive of about 50 μm to about 75 μm in thickness on one surface of the film, and a clearcoat layer on the opposite surface of the film, may be applied to provide supplemental protection to the motor vehicle surface.

In still other embodiments, a vehicle wrapping film, for example a clear (i.e., non-pigmented or slightly pigmented) vinyl film having a thickness of about 50 μm, with a pressure-sensitive adhesive having a thickness of about 25 μm on one surface of the film, and a printed or graphic layer on the opposite surface of the film (e.g., the 3M™ Scotchcal™ Gloss Overlaminate series, the 3M™ Scotchcal™ Luster Overlaminate series, or the 3M™ Scotchcal™ Matte Overlaminate series of vehicle wrapping films available from 3M Company, St. Paul, Minn., U.S.A.), with an outer clearcoat layer over the printed or graphic layer may be applied to both adorn the vehicle and provide supplemental protection to the motor vehicle surface.

References herein to painted exterior surfaces such as found in motor vehicles means panels having a basecoat/topcoat or a basecoat/clearcoat finish, optionally with a supplemental paint protection film or a vehicle wrapping film thereon, and references herein to an outer, clearcoat layer mean the outermost such layer of the painted exterior surface (whether it is provided by the topcoat or clearcoat of the panel, the clearcoat layer of a supplemental paint protection film, or the clearcoat layer of a vehicle wrapping film that has been applied to the panel).

In one embodiment, a kit for imparting an image to a painted exterior surface on a motor vehicle comprises a mask that is adapted to be removably attached to the outer clearcoat layer and an abrasive material that is capable of removing a portion of the outer clearcoat layer. The mask has a masked portion and an open portion that cooperate to define the image that is to be imparted to the painted exterior surface of the motor vehicle. As will be explained more fully below, the mask is applied to the painted exterior surface and the clearcoat layer is abraded in the area of the mask to generate an image having a matte finish region and an unabraded region. The kits further include one or more materials that are capable of providing the outer clearcoat layer in the matte finish region of the image with a surface gloss appearance that is consistent with the surface gloss appearance of the outer clearcoat layer in the unabraded region of the image.

Masks and Images that May be Created with them

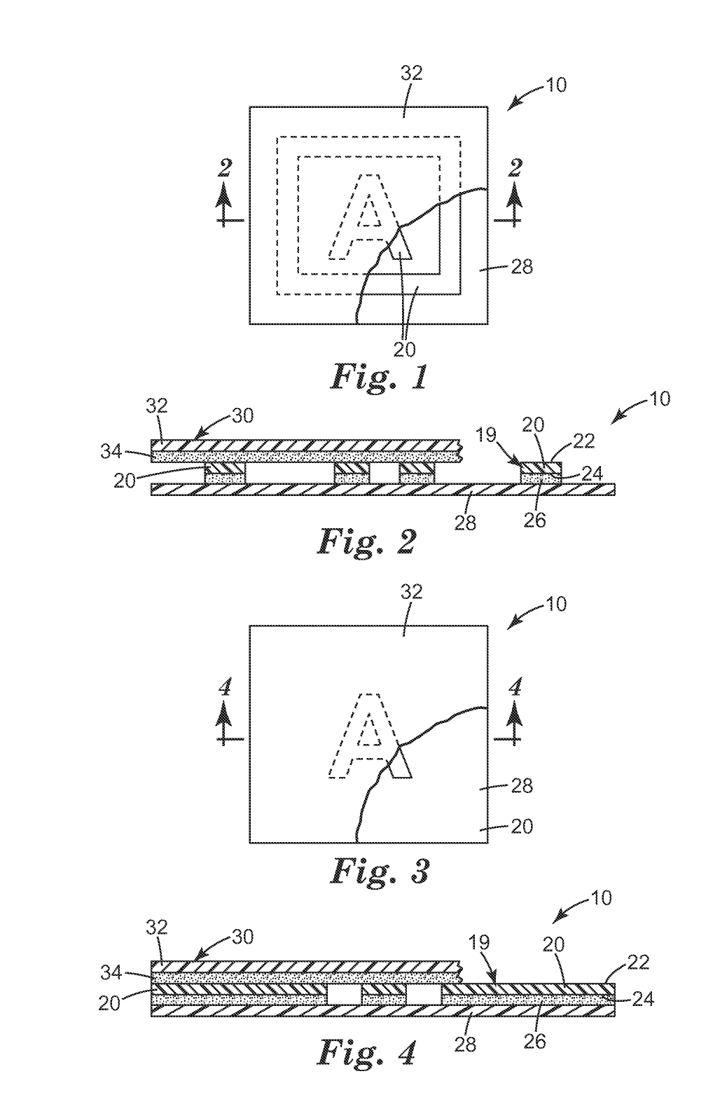

FIGS. 1 to 4 show two embodiments of a mask 10 that may be used to practice the methods described herein and that may be incorporated into kits for performing such methods. One embodiment is represented by FIGS. 1 and 2 and the other embodiment is represented by FIGS. 3 and 4.

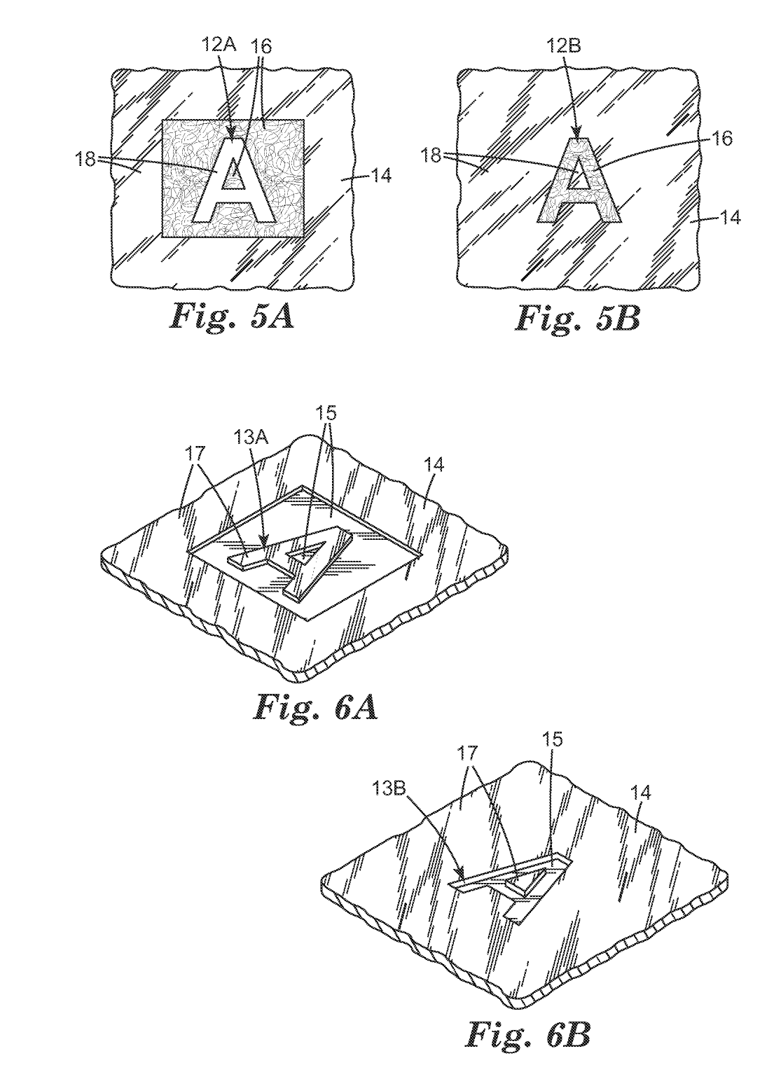

According to one method, mask 10 that is illustrated in FIGS. 1 and 2 may be used to impart image 12A (represented generally by the letter “A”) to a surface such as painted exterior surface 14 on a motor vehicle shown in FIG. 5A. With this same method, mask 10 that is illustrated in FIGS. 3 and 4 may be used to impart image 12B (also represented generally by the letter “A”) to a surface such as painted exterior surface 14 on a motor vehicle shown in FIG. 5B.

Image 12A and image 12B each include a matte finish region 16 and a distinct adjacent region 18. (For convenience, image 12A and image 12B may be regarded as and may be referred to as matte finish images.) Matte finish region 16 corresponds to the open portion of mask 10 and results from abrading the surface to which the mask is applied. Region 18 corresponds to the masked portion of mask 10 and is provided by the original surface. In this context, the “original” surface refers to that portion of the surface in image 12A or image 12 B that is adjacent to matte finish region 16 and that was not abraded during the process of imparting image 12A or image 12B to the surface. Matte finish region 16 may appear hazy, opaque, milky white, or scuffed.

In FIGS. 5A and 5B image 12A and image 12 B have been imparted to painted exterior surface 14 on a motor vehicle. Thus, matte finish region 16 results from abrading the clearcoat layer of the motor vehicle's painted exterior surface, and region 18 is provided by the original, usually glossy, painted exterior surface (i.e., it is usually a glossy region). In this context, the “original” surface refers to that portion of the clearcoat layer in image 12A or image 12B that is adjacent to matte finish region 16 and that was not abraded during the process of imparting image 12A or image 12B to surface 14. Despite the motor vehicle surface having been abraded, there is a smooth transition between the surface in matte finish region 16 and the adjacent, glossy region. For example, a user's finger drawn across the matte finish region 16 and adjacent region 18 should, in preferred embodiments, be unable to detect the boundary between the two regions.

Advantageously, as explained in more detail below, matte finish region 16 may be removed such that the clearcoat layer in this region is restored to or provided with a surface gloss appearance that is consistent with adjacent, unabraded, and usually glossy, region 18, and without painting the surface of the motor vehicle.

In a different method, mask 10 illustrated in FIGS. 1 and 2 may also be used to impart image 13A (represented generally by the letter “A”) to a surface such as painted exterior surface 14 on a motor vehicle shown in FIG. 6A. With this same method, mask 10 illustrated in FIGS. 3 and 4 may also be used to impart image 13B (again represented generally by the letter “A”) to a surface such as painted exterior surface 14 on a motor vehicle shown in FIG. 6B.

Image 13A and image 13B each include a recessed region 15 and an adjacent region 17 that is raised relative to recessed region 15. (For convenience, image 13A and image 13B may be regarded as and may be referred to as recessed images.) Recessed region 15 corresponds to the open portion of mask 10 and results from abrading the surface to which the mask is applied. Raised region 17 corresponds to the masked portion of mask 10 and is provided by the original surface. In this context, the “original” surface refers to that portion of the surface in image 13A or image 13B that is adjacent to recessed region 15 and that was not abraded during the process of creating recessed image 13A or recessed image 13B in the surface.

In FIGS. 6A and 6B recessed image 13A and recessed image 13 B have been created in painted exterior surface 14 on a motor vehicle. Thus, recessed region 15 results from abrading the clearcoat layer of the motor vehicle's painted exterior surface, and raised region 17 is provided by the original, usually glossy, painted exterior surface (i.e., it is usually a glossy region). In this context, the “original” surface refers to that portion of the clearcoat layer that is adjacent to recessed region 15 and that was not abraded during the process of creating recessed image 13A or recessed image 13B in surface 14. A visible edge, lip, step or shelf delineates the boundary between recessed region 15 and raised region 17. In some embodiments, a user's finger drawn across the recessed and raised regions of the image may be able to detect the boundary between the two regions.

Because recessed region 15 is created by abrading the clearcoat layer, it initially has a matte finish. However, and as explained more fully herein, as a result of further treating or finishing the clearcoat layer in the matte finish or recessed region, it is restored to or provided with a surface gloss appearance that is consistent with the surface gloss appearance of the clearcoat layer in the adjacent, unabraded, and raised region, and without painting the surface of the motor vehicle.

Mask 10

Turning now to FIGS. 1 to 4, mask 10 will be described in more detail. Similar reference numerals are used in conjunction with the two embodiments of mask 10 that are shown in FIGS. 1 to 4 because the two embodiments incorporate the same components as will be explained more fully hereinbelow. Mask 10 includes a masking layer 19 that comprises a masking film 20 having first and second opposed major surfaces 22 and 24, and a pressure-sensitive adhesive 26 disposed on one of the opposed major surfaces of masking film 20 (surface 24 in FIGS. 1 to 4). Preferably masking layer 19 is selected so as to exhibit several desirable properties.

For example, the masking layer is desirably abrasion resistant so that the masked portion of the mask will continue to protect the underlying painted exterior surface of the motor vehicle while the clearcoat layer in the open region is being abraded. For some embodiments, the masking layer should be sufficiently conformable and non-elastic that it can easily follow the complex, multi-planar contours typically found in motor vehicles. When stretched during application to fit a particular three-dimensional geometry, the masking layer should retain the three-dimensional shape that it has assumed. The masking layer should also be flexible and have a tear strength that permits the masking layer to bend around sharp corners and edges typically found in motor vehicles but without breaking or tearing.

For some embodiments, it is desirable for the masking layer to be easily and cleanly removed from the surface after the image has been imparted thereto and without leaving adhesive residue that must be subsequently removed or without the masking layer tearing into several pieces or shredding.

For some embodiments, it is desirable to select a pressure-sensitive adhesive that maintains adequate adhesion to the painted exterior surface of the motor vehicle even under damp or wet conditions in the event that the clearcoat layer is dampened or moistened during the abrading process.

Masking film 20 may be made of a wide variety of materials such as, for example, polymeric films, metalized polymeric films, metal foils, paper, and woven fabric. Masking film 20 is preferably made of a polymeric material and films used for motor vehicle graphics and decals or during customized painting of a motor vehicle to define the area being painted may be employed for masking film 20. Suitable polymeric films include, for example, vinyl, polyvinyl chloride, plasticized polyvinyl chloride, polyurethane, polyethylene, polypropylene, fluororesin, polytetrafluoroethlyene, polyester, polyimide, cellulose acetate, ethyl cellulose, and the like. Masking film 20 is preferably about 25 μm to about 75 μm thick.

Pressure-sensitive adhesive 26 may also be selected from a wide variety of materials and, in general, those pressure-sensitive adhesives that have been used in masking tapes intended for automotive masking applications are acceptable. Classes of pressure-sensitive adhesives suitable for use herein include tackified rubber adhesives (e.g., tackified natural rubber), olefins (e.g., poly-\acute{α}-olefins such as polyethylene, polypropylene, polybutylene, polyhexene and polyoctene), silicones, polyisoprene, polybutadiene, polyurethanes, styrene-isoprene-styrene and styrene-butadiene-styrene block copolymers, ethylene vinyl acetate, and other elastomers. Also useful as pressure-sensitive adhesives are tackified or untackified acrylic adhesives such as copolymers of an alkyl acrylate or alky methacrylate having, for example, an alkyl group which comprises from about 4 to 18 (or 4 to 12) carbon atoms such as n-butyl acrylate, 2-ethylhexylacrylate, isoctylacrylate, isononyl acrylate, octadecyl acrylate and the like, and a reinforcing monomer such as acrylic acid, methacrylic acid, itaconic acid, isobornyl acrylate, N,N-dimethylacrylamide, N-vinyl caprolactam, N-vinyl pyrrolidone, and the like. Optionally, the pressure-sensitive adhesive may be cross-linked to enhance the cohesive strength and other properties of the adhesive.

The pressure-sensitive adhesive may optionally include one or more additives such as, for example, initiators, fillers, plasticizers, tackifiers, chain transfer agents, fibrous reinforcing agents, woven and non-woven fabrics, foaming agents, antioxidants, stabilizers, fire retardants, viscosity enhancing agents, coloring agents, and mixtures thereof.

The thickness of the pressure-sensitive adhesive may vary widely depending on the intended application, and typically ranges from about 10 μm to about 50 μm. The total thickness of masking layer 19 is generally about 35 μm to about 125 μm.

Mask 10 further includes a release liner 28 to protect pressure-sensitive adhesive 26 until the user is ready to apply masking layer 19 to the surface to which the image is to be imparted. Release liner 28 may be selected from a broad range of materials and, in general, release liners and transfer liners known for use with motor vehicle graphics and decals are suitable. Release liner 28 should be capable of being placed in intimate contact with pressure-sensitive adhesive 26 and then subsequently removed without damaging the adhesive layer. Release liner 28 is typically a film (such as polyethylene, polypropylene or polyethylene terepthalate) or paper that has a silicone or fluorosilicone release coating disposed thereon. The surface of release liner 28 that bears against pressure-sensitive adhesive 26 may be smooth. Alternatively, it may include a network of microstructured channels that will impart air-release channels to pressure-sensitive adhesive 26 when mask layer 19 is laminated to the release liner.

Mask 10 also includes a removable pre-mask 30 that is attached to the major surface of masking film 20 that is opposite the major surface that carries pressure-sensitive adhesive 26 (i.e., major surface 22 in FIGS. 1 to 4). The construction of pre-mask 30 is similar to that of masking layer 19 and includes a top sheet 32 and a pressure-sensitive adhesive 34 disposed on one of the major surfaces of the top sheet. In general, the materials described above as being suitable for use as masking film 20 may be employed for top sheet 32, although polymeric films are particularly desirable because they may be transparent or translucent which can facilitate applying masking layer 19 to the surface to which the image will be imparted. The materials described above as being suitable for use as pressure-sensitive adhesive 26 may be used for pressure-sensitive adhesive 34, although pressure-sensitive adhesive 34 is selected so as to have less adhesion to masking film 20 and the surface to which masking layer 19 will be applied than pressure-sensitive adhesive 26 will have to the surface to which masking layer 19 will be applied.

Mask 10 may be readily assembled. Masking layer 19 may be produced by any conventional method for preparing pressure-sensitive adhesive articles. For example, the pressure-sensitive adhesive 26 may be directly coated out of water or an organic solvent onto masking film 20 or it may be hot-melt coated onto masking film 20. Coating may be accomplished with a knife coater, a Meyer bar coater, an extrusion die, etc., depending on the pressure-sensitive adhesive. Alternatively, the pressure-sensitive adhesive may be coated by any of these techniques onto a transfer liner, dried in air or in a low temperature oven, and then transfer-laminated to masking film 20 using heat and/or pressure as needed to ensure that a good bond is formed. This approach is especially useful if the surface of the pressure-sensitive adhesive that will be applied to the surface will include air-release channels because these channels can be incorporated into the transfer liner and imparted to the pressure-sensitive adhesive. In some cases, in order to improve adhesion of the pressure-sensitive adhesive, masking film 20 may be pretreated prior to coating using, for example, corona discharge, plasma discharge, flame treatment, electron beam irradiation, ultraviolet radiation, acid etching, or chemical priming.

Once masking layer 19 has been prepared it may be laminated to release liner 28. If the exposed layer of pressure-sensitive adhesive was not previously provided with air-release channels, release liner 28 may include these structures (if desired) so that they can be imparted to pressure-sensitive adhesive 26. Commercially available materials that may be used for masking layer 19 and release liner 28 include the Controltac™ and Controltac™ Plus brand graphic films available from 3M Company, St. Paul, Minn., U.S.A. that include a removable pressure-sensitive adhesive, especially those incorporating Comply™ brand pressure-sensitive adhesive having air release channels.

While mask 10 has been particularly described with reference to FIGS. 1 to 4, other constructions may be used for mask 10 depending on the image that is to be imparted and the skill of the user. For example, masking tapes conventionally employed when painting motor vehicles may be used to define certain images. Such masking tapes may comprise a backing formed from a vinyl or other polymeric film, crepe paper, or the like with a layer of pressure-sensitive adhesive (such as those described above) on one surface of the backing, and a backsize treatment on the other surface to facilitate winding the masking tape into a roll and unwinding it for use. Commercially available masking tapes suitable for use as a mask herein include Scotch™ Performance Masking Tape 233+ or 3M™ Vinyl Tape 471+ from 3M Company, St. Paul, Minn., U.S.A.

The masked and open portions of mask 10 may then be created according to the image that is desired to be imparted to the surface (for example, the painted exterior surface of a motor vehicle). A wide variety of images having a matte finish region 16 and a distinct, adjacent region 18 (for example, a glossy region if the image is imparted to a painted exterior surface of a motor vehicle), or having a recessed region 15 and an adjacent, raised region 17 (each of which may be a glossy region if the image is imparted to a painted exterior surface of a motor vehicle) may be created depending on the desires of the designer or the user. The image may be a logo, a graphic design, letters, numbers, words, symbols, shapes, or any combination of these. The regions of the imparted image that are intended to have a matte finish and the regions that are intended to have a glossy or other distinct appearance when adjacent to the matte finish region, or the regions of the imparted image that are intended to be recessed or raised depend on the desires of the designer or the user.

Once having determined the image to create, masking layer 19 is cut so as to correspond to the intended image and a portion of the masking layer is removed. The portion of masking layer 19 that is removed creates the open portion of mask 10 which, in turn, will provide recessed region 15 or matte finish region 16 in the imparted image. The portion of masking layer 19 that is not removed creates the masked portion of mask 10 and this, in turn, will provide raised region 17 or glossy (or other distinct adjacent) region 18 in the imparted image. Masking layer 19 may be cut by hand using a knife or a razor, or it may be cut by a die or a laser, using, for example, an automated or programmable cutting tool.

Once the unneeded portion of masking layer 19 has been removed, pre-mask 30 is laminated to major surface 22 of masking film 20 to complete the assembly of mask 10. (Pre-mask 30 may be produced by using any of the manufacturing techniques described in conjunction with masking layer 19.)

Applying the Mask to a Surface

At this point, a user may begin the process of imparting the desired image to the surface that is to be decorated. Once having selected the surface that is to be decorated with the image, the surface is thoroughly cleaned to remove any accumulated dirt, grime, dust and the like. For example, if the surface to be decorated is a painted exterior surface of a motor vehicle, then the surface may be prepared by washing it with a solution of detergent and water or a car shampoo that has been diluted according to the manufacturer's recommendation, and then rinsing the surface with water and drying it.

Masking layer 19 is then applied to the cleaned and dried surface. Release liner 28 is removed thereby exposing pressure-sensitive adhesive 26. Masking layer 19 along with pre-mask 30 is positioned on the surface so as to correspond with where the image is to be established. Certain pressure-sensitive adhesives (for example, those found in the Controltac™ and Controltac™ Plus brand graphic films available from 3M Company) allow for masking layer 19 to be slidably repositioned on the surface until the desire orientation is achieved. Once masking layer 19 has been properly positioned on the surface, it is pressed into contact with the surface so that pressure-sensitive adhesive 26 forms a firm, but removable, bond to the surface. This can be facilitated by drawing a squeegee, rubber roller, or similar device across pre-mask 30. Using a pressure-sensitive adhesive that has been provided with air release channels will discourage bubbles, wrinkles, or creases from forming in the masking layer. Alternatively, release liner 28 may be partially removed so as to partially expose pressure-sensitive adhesive 26. In this approach, masking layer 19 may be applied to the surface as described above while at the same time removing the rest of release liner 28 in a smooth, continuous motion.

Pre-mask 30 may then be removed by peeling it away from masking layer 19 and the surface that is to be decorated with the image. If pressure-sensitive adhesive 34 has been selected to have less adhesion to masking film 20 and the surface to be decorated than pressure-sensitive adhesive 26 has to this surface, then pre-mask 30 may be easily removed without disturbing masking layer 19. Removing pre-mask 30 establishes masked and unmasked regions on the surface to be decorated and the user will abrade the unmasked regions of this surface to generate the image (for example, image 12A, image 12B, image 13A or image 13B) represented by mask 10.

If mask 10 is provided by a masking tape, then sections of the masking tape are unwound from the roll, cut to the desired size and shape, arranged on the surface to be decorated so as to define the desired image, and pressed into contact with the surface so that the pressure-sensitive adhesive forms a firm, but removable, bond to the surface. This establishes the masked and unmasked regions on the surface to be decorated so that the user can abrade the unmasked regions to generate the image represented by the mask.

Abrasives for Abrading the Unmasked Region of the Surface

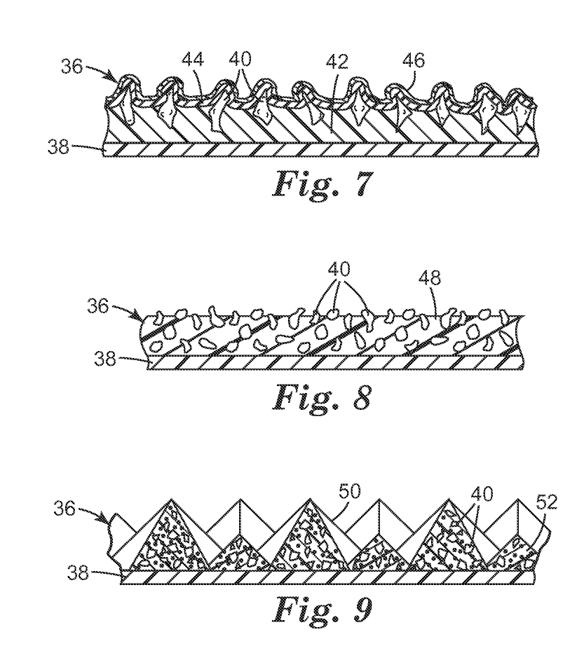

A broad range of abrasives may be used to abrade the unmasked region of the surface so as to generate the image represented by mask 10. Referring to FIGS. 7 to 9, the abrasives generally comprise an abrasive layer 36 affixed to a flexible backing 38. Abrasive layer 36 includes abrasive particles 40 anchored or dispersed in a binder. Suitable examples of flexible backing 38 and abrasive particles 40 are described below.

In one embodiment, one example of which is illustrated in FIG. 7, abrasive layer 36 comprises abrasive particles 40 anchored in a first binder, make resin, or make coat 42, with an overlying second binder, size resin, or size coat 44, and an optional third binder, supersize resin, or supersize coat 46 over size coat 44. Make coat 42 may comprise a glue or a cured resin and useful resins include acrylate, urethane, epoxy, polyester, etc. and blends thereof. Size coat 44 is applied over abrasive particles 40 and make coat 42. The size coat may also comprise a glue or a cured resinous adhesive and suitable examples include phenolic, aminoplast, urethane, acrylated urethane, epoxy, acrylated epoxy, isocyanurate, acrylated isocyanurate, ethylenically unsaturated, ureaformaldehyde, bis-maleimide and fluorene-modified epoxy resins, as well as mixtures thereof. Both the make and size coats may additionally comprise various optional additives such as fillers, grinding aids, fibers, lubricants, wetting agents, surfactants, pigments, antifoaming agents, dyes, coupling agents, plasticizers, and suspending agents. Optional super size coat 46 may be included to prevent or reduce the accumulation of swarf (the abraded material) between abrasive particles and acceptable materials include metal salts of fatty acids, urea-formaldehydes, waxes, mineral oils, crosslinked silanes, crosslinked silicones, fluorochemicals, and combinations thereof.

Make coat 42 may be prepared by mixing the components thereof, applying as a precursor to backing 38 such as by roll coating, spray coating, die coating, knife coating, and the like, and exposing to electron beam, visible light, ultraviolet light, or other suitable radiation for a time and at an intensity sufficient to polymerize or cure the binder resin precursor. Abrasive particles 40 may be applied until the first binder resin precursor has sufficiently cured that the particles will no longer adhere, for example, by drop coating, electrostatic coating, or magnetic coating. Size coat 44 may be subsequently applied over the abrasive particles and make coat 42 as a flowable liquid by roll coating, spray coating, gravure coating, or curtain coating, and then subsequently cured by drying, heating, or with electron beam, visible light, or ultraviolet light radiation. Supersize coating 46 may be applied and cured or dried in a similar manner.

In another embodiment, one example of which is illustrated in FIG. 8, abrasive layer 36 comprises abrasive particles 40 dispersed in a binder 48; typically, the abrasive particles are substantially uniformly distributed throughout the binder. Examples of suitable binders include organic resins that can be polymerized or cured under the influence of heat or radiation (e.g., electron beam, ultraviolet light, or visible light) such as phenolic, urea-formaldehyde, melamine formaldehyde, acrylated urethane, acrylated epoxy, ethylenically unsaturated resins, and the like. Optional components that may be included with the binder resin are grinding aids, fibers, fillers, thixotropic agents, wetting agents, pigments, dyes, lubricating agents, anti-static agents, plasticizers, coupling agents, suspending agents, and the like. Abrasive layer 36 is typically applied to flexible backing 38 by preparing a slurry containing the abrasive particles, a precursor for the binder resin, and any optional additives, and then coating the slurry onto the backing by roll coating, gravure coating, knife coating, spray coating, transfer coating, vacuum die coating, or die coating, and then exposing the slurry to suitable radiation for a time and at an intensity sufficient to polymerize or cure the binder resin precursor.

In another embodiment, one example of which is illustrated in FIG. 9, abrasive layer 36 is a structured abrasive layer comprising precisely shaped abrasive composites 50 in which abrasive particles 40 are dispersed throughout a binder 52. A structured abrasive layer (sometimes referred to as a shaped abrasive layer) refers to an abrasive layer comprised of abrasive particles dispersed in a binder, wherein the abrasive layer has other than the typical topographic surface as may be encountered in conventional coated abrasives (such as illustrated in FIGS. 7 and 8), but instead has a textured surface having raised portions and recessed portions which may be in an ordered or a random pattern. Precisely-shaped abrasive composites are characterized by relatively smooth-surfaced sides that are bounded and joined by well-defined edges having distinct edge lengths with distinct endpoints defined by the intersections of the various sides. Precisely shaped abrasive composites may have any three-dimensional shape that results in at least one raised feature or one recess on the exposed surface of the structured abrasive layer. Useful shapes include, for example, cubic, prismatic, pyramidal (e.g., square pyramidal or hexagonal pyramidal), truncated pyramidal, conical, frusto-conical, pup tent-shaped, and ridge-shaped.

In this context, “bounded” and “boundary” refer to the exposed surfaces and edges of each composite that delimit and define the actual three-dimensional shape of each abrasive composite. These boundaries are readily visible and discernible when a cross-section of an abrasive article is viewed under a scanning electron microscope. The boundaries separate and distinguish one precisely shaped abrasive composite from another even if the composites abut each other along a common border at their bases. By comparison, in an abrasive composite that is not precisely shaped, the boundaries and edges are not well-defined.

Useful binder precursors that may be cured to form the binders for structured abrasives include, for example, thermally curable resins and radiation curable resins such as phenolic resins, aminoplast resins, urea-formaldehyde resins, melamine-formaldehyde resins, urethane resins, polyacrylates, alkyd resins, epoxy resins, isocyanurate resins, allyl resins, furan resins, cyanate esters, polyimides, and mixtures thereof. The binder precursors may additionally contain reactive diluents, adhesion promoting monomers, photoinitiators, grinding aids, fillers, wetting agents, chemical blowing agents, surfactants, pigments, coupling agents, dyes, energy receptors, glass bubbles or beads, inflatable bubbles, polymeric particles, solid or liquid waxes, potassium fluoroborate, lithium stearate, cryolite, polyurethane particles, or polysiloxane gum.

Structured abrasive layers may be prepared by the depositing the slurry onto a backing, (optionally in a pattern by screen or gravure printing) or contacting the slurry with a backing, partially polymerizing the binder precursor in the slurry (for example, by exposure to electron beam radiation, ultraviolet light, visible light, etc.) to render at least the surface of the slurry plastic but non-flowing, embossing a pattern into the partially polymerized slurry, and then further polymerizing the partially polymerized slurry. The slurry may also be coated directly onto a production tool having precisely shaped cavities formed therein and then brought into contact with the flexible backing, or coated on the flexible backing and brought in contact with the production tool. In this approach, the slurry is typically then solidified or cured while it is present in the cavities of the production tool. Alternatively, the slurry may be coated through a screen that is in contact with the backing with the slurry typically being further polymerized while it is present in the openings of the screen thereby forming a plurality of shaped abrasive composites generally corresponding in shape to the screen openings.

Abrasive particles 40 useful in any of the several embodiments described herein can generally be divided into two classes: natural abrasives and manufactured abrasives. Examples of useful natural abrasives include diamond, corundum, emery, garnet, buhrstone, chert, quartz, sandstone, chalcedony, flint, quartzite, silica, feldspar, natural crushed aluminum oxide, pumice, and talc. Examples of manufactured abrasives include boron carbide, cubic boron nitride, fused alumina, ceramic aluminum oxide, heat-treated aluminum oxide, fused alumina zirconia, glass, glass ceramics, silicon carbide, iron oxides, tantalum carbide, chromia, cerium oxide, tin oxide, titanium carbide, titanium diboride, synthetic diamond, manganese dioxide, zirconium oxide, sol gel alumina-based ceramics, silicon nitride, and agglomerates thereof. The abrasive particles ordinarily have a particle size of at least about 0.1 μm up to about 1500 μm or up to about 1300 μm. In some embodiments, the abrasive particles have a size within a range of from JIS grade 800 (14 μm at 50% midpoint) to JIS grade 4000 (3 μm at 50% midpoint) or even JIS grade 6000 (2 μm at 50% midpoint), inclusive. Referring to the abrasive grit size on the Federation of European Producers of Abrasives (FEPA) or ISO scale, abrasives measuring at least P500 may be used, for example, P500, P1000, P1200, P3000, P4000 or P6000 abrasives and those that are in between these.

In each embodiment, abrasive layer 36 is affixed to flexible backing 38, suitable examples of which include paper, cloth, non-woven fabric, polymeric films (e.g., polyester, polypropylene, polyethylene, vinyl, etc.) which films may be primed, and foams. The backing may be treated so as to seal the backing and/or modify some of its physical properties. The backing may also have an attachment mechanism (e.g., a pressure sensitive adhesive, one part of a hook and loop attachment system, a threaded projection, or an intermeshing attachment system) on its back surface so that the abrasive can be secured to a support pad or a back-up pad.

Flexible foam backings are particularly preferred, especially if the foam is resilient or compressible such that its volume can be reduced by at least 10 percent through an applied mechanical force without substantially crushing or fusing the foam. In general, any flexible, resilient foam having at least one coatable surface to which the abrasive layer may be affixed can be used. Preferably, the foam has a sheet-like configuration with at least one major surface being planar.

Useful foams include elastic foams such as, for example, chloroprene rubber foams, ethylene/propylene rubber foams, butyl rubber foams, polybutadiene foams, polyisoprene foams, EPDM polymer foams, polyurethane foams, ethylene-vinyl acetate foams, neoprene foams, and styrene/butadiene copolymer foams. Useful foams also include thermoplastic foams such as, for example, polyethylene foams, polypropylene foams, polybutylene foams, polystyrene foams, polyamide foams, polyester foams, and plasticized polyvinyl chloride foams. The foam layer may be of an open-cell or closed-cell variety, although typically, if the abrasive article is intended for use with liquids, an open-cell foam having sufficient porosity to permit the entry of liquid is desirable. Particular examples of useful open cell foams are polyester polyurethane foams, commercially available from “pinta foamtec, inc.,” Minneapolis, Minn., U.S.A. under the trade designations “R-200U” and “R-600U.”

The thickness of the foam backing is typically in a range of from about 1 to about 50 millimeters, however, other thickness may also be used. Typically, the bulk density of the foam as determined by ASTM D-3574 is greater than about 0.03 gram per cm³ (2 lbs per ft³), however lower density foam layers may also be used. In some embodiments, the foam layer has a bulk density of about 0.03 to about 0.10 grams per cm³ (1.8-6 lbs per ft³). The foam may have an elongation in a range of from about 85 to about 150% (i.e., the stretched length of the foam minus the unstretched length of the foam all divided by the unstretched length of the foam and then multiplied by 100 equals 85 to 150%). Structured abrasive layers are especially useful, particularly when combined with a flexible foam backing. Suitable, commercially available structured abrasives include, for example, the 3M™ Trizact™ line of products commercially available from 3M Company, Saint Paul, Minn., U.S.A. such as the 3M™ Trizact™, 3M™ Trizact™ Hookit™, and 3M™ Trizact™ Hookit™ II product lines using P1000 to P3000 grade abrasive.

Imparting the Desired Image to a Surface

The unmasked portion of the surface to be decorated (corresponding to the open portion of mask 10) is abraded (sanded) using a suitable abrasive such as those described above. The surface may be abraded by hand (e.g., by using a foam sanding block). Alternatively, the surface may be abraded with the aid of a powered sanding machine taking care to not sand through masking layer 19 or to cause it to lift off the surface. The abrasive may be mounted to the machine directly or by using an intermediate pad and/or back-up pad to which the abrasive is secured by, for example, by a pressure sensitive adhesive, a hook and loop fastener, or other means. Orbital, random orbital (dual-action), or rotary sanding machines may all be used. Although the surface may be abraded under wet or dry conditions, damp sanding is preferred, especially if the surface is the painted exterior surface of a motor vehicle.

Imparting a Matte Finish Image to a Surface

When imparting a matte finish image to a surface, abrading should be conducted so as to sand all unmasked portions of the surface evenly, applying smooth, even, continuous pressure and a continuous motion for best results. The abrading process will remove a thin layer of the surface and over-sanding (i.e., abrading too deeply) should be avoided.

When imparting a matte finish image (for example image 12A or image 12B) to a painted exterior surface on a motor vehicle by abrading the clearcoat layer, over-sanding can be avoided by paying close attention to the motor vehicle surface and stopping once the area being abraded appears to have a uniform matte finish. That is, the abraded surface appears uniformly opaque (as compared to the adjacent, usually glossy, clearcoat surface), hazy, milky white, or scuffed.

In general, no more than about 0.01 μm or 0.1 μm of the clearcoat layer may need to be removed to impart a matte finish image, up to about 3 μm or up to about 5 μm. The amount of time required to abrade the surface in order to obtain this appearance will vary depending on how much pressure is applied during the abrading process, the original condition of the surface, and the grade or grit size of the abrasive particles in the abrasive layer (i.e., how coarse or fine they are). As coarser abrasives are used, the amount of time required to abrade the surface will decrease. For example, if using a P3000 grade abrasive it may take about 5 to about 10 seconds to abrade an unmasked area on a painted exterior surface of a motor vehicle measuring about 18 square inches (about 116 square centimeters). With a P3000 grade abrasive, about three back and forth passes over the unmasked area should remove a sufficient amount of the clearcoat layer. If a P1000 grade abrasive is used instead, the same sized unmasked area on the motor vehicle surface may be abraded for no more than about 5 seconds.

Broadly, an area measuring about 18 square inches may be abraded for about 45 seconds or less, or about 30 seconds or less, or about 10 seconds or less, or about 5 seconds or less, depending on the factors noted above. In general, finer abrasives are preferred over coarser abrasives as they are more forgiving and easier to control in that the longer sanding time decreases the chance of over-sanding the surface. In this regard, abrasives in the range of P1000 to P6000 or P1000 to P30000 are useful, especially if they are structured abrasives on a flexible foam backing.

Once the surface has been abraded, the masking layer may be removed by peeling it from the surface to which it had been attached. Preferably, the masking layer can be removed in a single, continuous motion without tearing or shredding. The abraded area should then be wiped clean of any adhesive residue or accumulated dust or sanding debris.

The surface may display an image, for example, like that shown in FIG. 5A or 5B having a matte finish region 16 in an area corresponding to the open portion of the mask and a distinct, adjacent, unabraded region 18 in an area corresponding to the masked portion of the mask.

If the surface is a painted exterior surface of a motor vehicle, unabraded region 18 is typically a glossy region (it has a glossy finish) corresponding to the original, usually glossy surface of the motor vehicle's painted exterior. Despite the motor vehicle surface having been abraded, there is a smooth transition between the surface in matte finish region 16 (i.e., the abraded area) and the adjacent, glossy region (i.e., the unabraded area). For example, a user's finger drawn across the abraded and unabraded areas should, in preferred embodiments, be unable to detect, by touch alone, the boundary between the abraded area and the unabraded area.

If upon inspecting the image, the user is dissatisfied with the result, for example because the image was not properly positioned on the surface or because the image is not to the user's liking, then the matte finish region of the image may be removed and the outer clearcoat layer provided with a gloss appearance consisting with that in the unabraded region by employing conventional motor vehicle paint finishing techniques but without having to repaint the surface as described below. In the previous matte finish region, the surface gloss appearance of the outer clearcoat layer will be consistent with the surface gloss appearance of the clearcoat layer in the unabraded region of the image. A consistent surface appearance means that the gloss of the outer clearcoat layer in the matte finish region is similar to and consistent with the gloss of the outer clearcoat layer in the unabraded region of the image. This may be referred to at times as surface gloss appearance that is consistent.

This will provide the clearcoat layer of a painted exterior surface on a motor vehicle with a surface gloss appearance that is consistent with the usually glossy surface appearance of the clearcoat layer in the unabraded region (i.e., the gloss of the outer clearcoat layer in the two regions is similar or consistent), but without having to repaint the vehicle surface. In some embodiments this means that there may be no visible scratches in the previous matte finish region and/or an outline of the previously applied image will not be detected. In other embodiments this means that the clearcoat layer in the previous matte finish region may display an “orange peel” surface texture consistent with that of the adjacent, unabraded region.

In a similar way, the user may remove the image long after it has been applied, for example because the user no longer wishes to display the image. Once any previously applied image has been removed, the restored surface appearance may be retained or another image may be imparted to the surface by following the techniques described herein. The subsequent image may be the same as the previously applied image or it may be different.

Imparting a Recessed Image to a Surface

When imparting a recessed image to a surface, abrading should be conducted so as to sand all unmasked portions of the surface evenly, applying smooth, even, continuous pressure and a continuous motion for best results. When imparting a recessed image (for example image 13A or image 13B) to a painted exterior surface on a motor vehicle by abrading the clearcoat layer, somewhat deeper sanding is possible as compared to when imparting a matte finish image to the surface, but over-sanding (i.e., abrading so deeply that the clearcoat layer is sanded through or that its thickness is reduced to a level where it will be unable to adequately protect the underlying base coat) is still to be avoided.

When abrading the clearcoat layer of a painted exterior surface on a motor vehicle to impart a recessed image, over-sanding can be avoided by paying close attention to the motor vehicle surface and stopping once the area being abraded appears to have a uniform matte finish (i.e., the abraded surface appears uniformly opaque (as compared to the adjacent, glossy clearcoat surface), hazy, milky white, or scuffed), and there is some evidence that a recessed region of the image has been established (e.g., it can be seen by visual inspection or it may be detected by finger touch) or it is believed that the surface has been sufficiently abraded to create a recessed region.

In general, sufficient clearcoat layer is removed so as to create a visible edge in the final image (i.e., the image that results from the additional finishing steps that provide the clearcoat layer in the recessed region of the image with a surface appearance that is consistent with the surface appearance of the clearcoat layer in the raised region of the image). The actual amount of the clearcoat layer that is removed in order to create a visible edge depends in part on the transition between the recessed and raised regions of the image. A more gradual transition makes the edge less distinct and additional clearcoat layer may be removed to make the edge more distinct.

Within these guidelines, when imparting a recessed image to a painted exterior surface on a motor vehicle, at least about 0.1 μm or up to about 10 μm of the clearcoat layer may be removed while still retaining about 50% or more of the original thickness of the clearcoat layer. The amount of time required to abrade the surface in order to obtain the recessed image will vary depending on how much pressure is applied during the abrading process, the original condition of the surface, and the grade or grit size of the abrasive particles in the abrasive layer (i.e., how coarse or fine they are). As in the case of imparting a matte finish image, when coarser abrasives are used, the amount of time required to abrade the surface will decrease. For example, if using a P3000 abrasive it may take about 15 seconds to about 90 seconds to abrade an unmasked area on a painted exterior surface of a motor vehicle measuring about 18 square inches (about 116 square centimeters). With a P3000 grade abrasive, about 30 back and forth passes over the unmasked area should remove a sufficient amount of the clearcoat layer. If a P1000 abrasive is used instead, the same sized unmasked area on the motor vehicle surface may be abraded for about 5 seconds to about 30 seconds. With a P1000 abrasive, about 10 back and forth passes over the unmasked area should remove a sufficient amount of the clearcoat layer.

Broadly, an area measuring about 18 square inches may be abraded for about 5 seconds or less, or about 30 seconds or less, or about 60 seconds or less, or about 120 seconds or less, depending on the factors noted above. In general, finer abrasives are preferred over coarser abrasives as they are more forgiving and easier to control in that the longer sanding time decreases the chance of over-sanding the surface. In this regard, abrasives in the range of P1000 to P3000 are useful, especially if they are structured abrasives on a flexible foam backing.

Once the surface has been abraded, the masking layer may be removed by peeling it from the surface to which it had been attached. Preferably, the masking layer can be removed in a single, continuous motion without tearing or shredding. The abraded area should then be wiped clean of any adhesive residue or accumulated dust or sanding debris.

The surface may display a recessed image having a recessed region in an area corresponding to the open portion of the mask and an adjacent, raised, unabraded region in an area corresponding to the masked portion of the mask (although the recessed region may become more apparent once it has been further treated as described below).

Where the surface is a painted exterior surface of a motor vehicle, the raised region typically has a glossy appearance corresponding to the original glossy surface appearance of the motor vehicle's painted exterior. At this point, however, the recessed region has a matte finish (i.e., it appears hazy, opaque, milky white, or scuffed). Typically the recessed region will be further treated to remove the matte finish and provide the surface of the outer clearcoat layer with a surface gloss appearance consistent with that in the raised region, while still maintaining it as a recessed region of the image. As described below, this may be accomplished by employing conventional motor vehicle paint finishing techniques but without having to repaint the vehicle surface. In the area of the previous matte finish, the surface gloss appearance of the outer clearcoat layer will be consistent with the surface gloss appearance of the outer clearcoat layer in the adjacent, unabraded, and raised region. A consistent surface appearance means that the gloss of the outer clearcoat layer in the matte finish region is similar to and consistent with the gloss of the outer clearcoat layer in the unabraded region of the image. This may be referred to at times a surface gloss appearance that is consistent.

This will provide the clearcoat layer of a painted exterior surface on a motor vehicle with a surface gloss appearance that is consistent with the usually glossy surface appearance of the clearcoat layer in of the unabraded and raised region (i.e., the gloss of the outer clearcoat in the area of the previous matte finish and the unabraded area is similar or consistant), but without having to repaint the vehicle surface. In some embodiments this means there may be no visible scratches in the clearcoat layer in recessed region of the image. In other embodiments, this means that the clearcoat layer in the recessed region may display an “orange peel” texture consistent similar to that of the clearcoat layer in the unabraded and raised region. A visible edge, lip, step or shelf will delineate the recessed region of the image from the raised region of the image.

Conventional Motor Vehicle Paint Finishing Techniques

As noted above, conventional motor vehicle paint finishing techniques may be used to remove a matte finish image and restore the surface of the clearcoat layer to (i.e., provide the clearcoat layer surface with) an appearance that is consistent with the surface appearance of the clearcoat layer in the adjacent, unabraded region, but without having to repaint the exterior surface of the motor vehicle. Also, as noted above, these techniques may be used to further treat the recessed region in a recessed image to remove the initial matte finish and restore the surface of the recessed region to (i.e., provide the surface of the recessed region with) an appearance that is consistent with the unabraded and raised region (while still maintaining it as a recessed region), but without having to repaint the vehicle surface as described below. As mentioned before, a consistent surface appearance means that the gloss of the outer clearcoat layer in the matte finish region is similar to and consistent with the gloss of the outer clearcoat layer in the unabraded region of the image.

One conventional motor vehicle paint finishing technique involves a series of sequential steps: (1) optionally sanding the motor vehicle surface in the area of the matte finish region or the initial matte finish of the recessed region; (2) optionally, refining sanding scratches; (3) compounding; (4) machine polishing; and (5) optionally, eliminating any swirl marks.

If the image was applied to the painted exterior surface of the motor vehicle using a relatively coarse abrasive (e.g., an abrasive that is more coarse than a P3000 abrasive), then it may be helpful to initially and optionally damp sand the motor vehicle surface in the area of the image using a P1500 or similar abrasive, especially one suited for sanding a motor vehicle clearcoat such as, for example, the 3M™ Trizact™ Hookit™ Clearcoat Sanding Disc or the 3M™ Trizact™ Hookit™ II Clearcoat Sanding Disc, each of which is commercially available from 3M Company, St. Paul, Minn., U.S.A. Employing a soft interface pad may be useful in matching the texture and contour of the sanded area with the surrounding areas on the motor vehicle surface. If the image was applied to the motor vehicle surface using a relatively fine grade abrasive, then it may be possible to eliminate this initial sanding step.

After sanding the motor vehicle surface in the area of the matte finish region or the initial matte finish of the recessed region (or if it is determined that this optional step may be skipped), then any sanding scratches that are present in the area of the image (either resulting from the initial application of the image or from the initial sanding step, or both), may be removed or refined. This step is also optional and depends on the extent to which any scratches are present. This step may be carried out, for example, by damp sanding the motor vehicle surface in the area of the matte finish or recessed region using a P3000 or similar abrasive, especially one suited for refining scratches in a motor vehicle clearcoat. Examples of such an abrasive include the 3M™ Trizact™ Hookit™ Foam Disc and the 3M™ Trizact™ Hookit™ II Foam Disc, each of which is commercially available from 3M Company. As in the initial sanding step, using a soft interface pad may be helpful in matching the texture and contour of the sanded area with the surrounding area on the motor vehicle's painted exterior surface.

Any sanding scratches that remain after the previous scratch refinement step has been completed (if performed) may be removed in a compounding step. Alternatively, the compounding step may be the first step. For example, the motor vehicle surface in the area of the matte finish or recessed region may be buffed with a rubbing compound that is conventionally used for buffing motor vehicle surfaces, one example of which is 3M™ Perfect-It™ Rubbing Compound, commercially available from 3M Company. The rubbing compound may be applied using traditional buffing techniques, for example by employing a powered, rotary buffer operating at a speed of 1,200-2,000 rpm and fitted with a suitable buffing pad which may be formed of wool, foam or other materials. The 3M™ Perfect-It™ Wool Compounding Pad, the 3M™ Perfect-It™ Low Linting Wool Compounding Pad, and the 3M™ Perfect-It™ Foam Compounding Pad are examples of suitable, commercially-available (from 3M Company) buffing pads that may be used.

The just-described compounding step may (and typically does) leave swirl marks on the surface of the motor vehicle. These can be removed by machine polishing the motor vehicle surface in the area of the matte finish or recessed region with an appropriate polish such as those conventionally used for polishing motor vehicle surfaces (e.g., 3M™ Perfect-It™ Machine Polish, commercially available from 3M Company). The polishing compound may be applied using traditional polishing techniques, for example by employing a powered, rotary buffer operating at a speed of 1,200-2,000 rpm fitted with a suitable polishing pad (such as the 3M™ Perfect-It™ Foam Polish Pad commercially available from 3M Company) and applying light to medium pressure to the motor vehicle surface. The surface may be additionally improved by wiping with a detail cloth, for example, the 3M™ Perfect-It™ detail cloth (yellow) commercially available from 3M Company.

Any fine swirl marks that remain may be removed in an optional swirl elimination step by machine polishing the motor vehicle surface in the area of the matte finish or recessed region with an appropriate fine or ultrafine grade polish, such as those conventionally used for finish polishing motor vehicle surfaces, one example of which is 3M™ Perfect-It™ Ultrafine Machine Polish, commercially available from 3M Company. The fine finish polishing compound may be applied using traditional finish polishing techniques. For example, a powered, rotary buffer operating at a speed of 1,200-2,000 rpm and fitted with a suitable fine polishing pad (e.g., the 3M™ Perfect-It™ Ultrafine Foam Polishing Pad commercially available from 3M Company) may be employed with light to medium pressure applied to the motor vehicle surface. The surface may be additionally improved by wiping with a detail cloth, one example of which is the 3M™ Perfect-It™ detail cloth (blue) commercially available from 3M Company.

Whether the surface in the area of the previously imparted matte finish image or the initial matte finish in the recessed region of a recessed image has been acceptably restored to or provided with an appearance that is consistent with the surface appearance of the adjacent, unabraded area is generally determined by visually inspecting the treated surface and comparing it to the surface of the unabraded area. In the context of a painted exterior surface on a motor vehicle, the treated clearcoat layer, in some embodiments, should not show scratches that are visible to the unaided human eye. In other embodiments, the “orange peel” surface texture of the clearcoat layer in the treated area should be consistent with the “orange peel” surface texture in the clearcoat layer in the unabraded area. In other embodiments, the treated clearcoat layer will not show scratches that are visible to the unaided human eye and an “orange peel” surface texture consistent with the “orange peel” surface texture in the adjacent, unabraded area will be evident. When removing a matte finish image, the unaided human eye should be unable to detect an outline of the previously applied image. When further treating a recessed image, there should be a visible edge delineating the recessed region from the raised region.

### EXAMPLES

The invention will be more fully appreciated by referring to the examples that follow. The following abbreviations are used in the examples:

cm: centimeters

kPa: kilopascals

mil: 10⁻³ inches

mm: millimeters

psi: pounds per square inch

m: micrometers

“Masking film” refers to an adhesive-coated, opaque white screen print film on a microreplicated release liner, one surface of the film having an image receptive surface and the opposite surface having a pressure-sensitive adhesive, commercially available from 3M Company, St. Paul, Minn., U.S.A. under the trade designation “CONTROLTAC GRAPHIC FILM WITH COMPLY V3 ADHESIVE IJ180-CV3-10.”

“Automotive masking tape” refers to Scotch™ Performance Masking Tape 233+ commercially available from 3M Company.

“Pre-mask” refers to a double-sided adhesive transfer tape on a release liner, one surface of the tape having a repositionable adhesive and the opposite surface having a permanent adhesive, commercially available from 3M Company under the trade designation “REMOVEABLE REPOSITIONABLE TAPE 9415PC.”

“Test panel” refers to an 18 inch by 24 inch by 32 mil (45.7 cm by 609.6 cm by 0.8 mm) primed, type “270AB921 BC” black painted, “RK8148 CC” clear-coated cold rolled steel test panel, obtained from ACT Laboratories, Inc., Hillsdale, Michigan, U.S.A., which represents a typical painted exterior surface found on a motor vehicle.

“Paint protection film” refers to a urethane film having a pressure-sensitive adhesive coated on one major surface thereof and a clearcoat layer on the opposed major surface thereof, with a total thickness of about 8 mils (203.2 m), commercially available from 3M Company under the trade designation “SCOTCHGARD PAINT PROTECTION FILM, PART No. 84812.”

“P1000 abrasive foam disc” refers to a 3-inch (7.6 cm) diameter foam-backed abrasive disc with a P1000 grade structured abrasive layer, commercially available from 3M Company under the trade designation “TRIZACT BLENDING DISC, PART No. 02091.”

“P1200 abrasive film disc” refers to a 3-inch (7.6 cm) diameter film-backed abrasive disc with a P1200 grade coated abrasive layer, commercially available from 3M Company under the trade designation “HOOKIT FINE FINISHING FILM DISC, PART No. 00908.”

“P1500 abrasive film disc” refers to a 3-inch (7.6 cm) diameter die-cut sample of a film-backed abrasive disc with a P1500 grade structured abrasive layer, commercially available from 3M Company under the trade designation “TRIZACT CLEARCOAT SANDING DISC, PART No. 02088.”

“P3000-3 abrasive foam disc” refers to a 3-inch (7.6 cm) diameter foam-backed abrasive disc with a P3000 grade structured abrasive layer, commercially available from 3M Company under the trade designation “TRIZACT FOAM DISC, PART No. 02087.”

“P3000-6 abrasive foam disc” refers to a 6-inch (15.2 cm) diameter foam-backed abrasive disc with a P3000 grade structured abrasive layer, commercially available from 3M Company under the trade designation “TRIZACT FOAM DISC, PART No. 02085.”

“3-inch interface pad” refers to a 3-inch (7.6 cm) diameter foam interface pad commercially available from 3M Company under the trade designation “HOOKIT SOFT INTERFACE PAD, PART No. 05771.”

“6-inch interface pad” refers to a 6-inch (15.2 cm) diameter foam interface pad commercially available from 3M Company under the trade designation “HOOKIT SOFT INTERFACE PAD, PART No. 05777.”

“3-inch backup pad” refers to a 3-inch (7.6 cm) diameter backup pad commercially available from Chicago Pneumatic, Rock Hill, South Carolina, U.S.A., PART No. 8940158330.

“6-inch backup pad” refers to a 6-inch (15.2 cm) diameter backup pad commercially available from 3M Company under the trade designation “CLEAN SAND PAINTER'S BACKUP PAD, PART No. 05551.”

“8-inch backup pad” refers to an 8-inch (20.3 cm) diameter backup pad commercially available from 3M Company under the trade designation “CLEAN SAND PAINTER'S BACKUP PAD, PART No. 05718.”

“Compounding pad” refers to an 8-inch (20.3 cm) diameter foam compounding pad commercially available from 3M Company obtained under the trade designation “PERFECT-IT FOAM COMPOUNDING PAD, PART No. 05723.”

“Polishing pad” refers to an 8-inch (20.3 cm) diameter foam polishing pad commercially available from 3M Company under the trade designation “PERFECT-IT FOAM POLISHING PAD, PART No. 05738.”

“Rubbing compound” refers to “PERFECT-IT RUBBING COMPOUND, PART No. 06085,” commercially available from 3M Company.

“Machine polish” refers to a fine polishing compound commercially available from 3M Company under the trade designation “PERFECT-IT MACHINE POLISH, PART No. 06064.”

“Microfiber cloth” refers to “3M™ PERFECT-IT™ DETAIL CLOTH NO. 06017” commercially available from 3M Company.

Mask Preparation and Application—Method A

A mask suitable for applying an image to a painted exterior surface such as found on a motor vehicle was prepared. The image was in the shape of a set of flames and measured approximately 15 cm by 20 cm. The mask was prepared by cutting out a 30 cm by 30 cm section of masking film using a razor blade. An image in the shape of a set of flames was then created by cutting the masking film with a razor blade and removing portions of the masking film to create the masked and open regions in the mask, the set of flames being represented by the open region. The repositionable face of an approximately 25 cm by 25 cm section of pre-mask was then applied over the image receptive surface of the masking film. The microreplicated release liner associated with the masking film was removed and the resulting exposed adhesive face of the mask was securely applied to the clear coat surface of the test panel. The pre-mask and its associated release liner were then removed to reveal the masking layer having the set of flames.

Mask Preparation and Application—Method B

A mask suitable for applying an image to a painted exterior surface such as found on a motor vehicle was prepared. Sections of automotive masking tape were securely applied to the clear coat surface of the test panel in the shape of a rectangle measuring 3 inches (7.6 cm) by 6 inches (15.2 cm), the masking tape defining a frame that represented the outer border of the rectangle.

### Example 1

A mask was prepared and applied to the clearcoat layer of the test panel according to “Mask Preparation and Application—Method A.” A P3000-3 abrasive foam disc was attached to a 3-inch interface pad and a 3-inch backup pad and assembled on to a random orbital sander, model “CP7200S MINI RANDOM ORBITAL SANDER” from Chicago Pneumatic, Rock Hill, South Carolina, U.S.A. The clearcoat surface of the test panel was sprayed lightly with water in the open area of the masking layer and then evenly damp-sanded in two to three passes using a line pressure of 40 psi (275.8 kPa) and for a total sanding time of approximately 10 seconds. The masking layer was then removed to reveal a distinct matte finish region in the shape of a set of flames surrounded by a glossy region provided by the original clearcoat finish of the test panel.

The ability to remove the matte finish region and restore the clearcoat layer to (provide the clearcoat layer with) a surface appearance consistent with the surface appearance of the glossy clearcoat layer in the unabraded region of the image by employing conventional motor vehicle paint finishing techniques but without repainting the vehicle was then demonstrated.

A compounding pad was attached to an 8-inch backup pad and assembled onto a “DW849” sander polisher from DeWalt Industrial Tool Company, Baltimore, Md., U.S.A. The test panel was then buffed with rubbing compound for approximately one minute. An 8-inch foam polishing pad was attached to an 8-inch backup pad and, using the sander polisher, the test panel was polished with machine polish for approximately one minute to remove swirl marks. Finally, the test panel was sprayed with a 50% by weight aqueous solution of isopropyl alcohol and manually wiped with a microfiber cloth.

The surface gloss appearance of the clearcoat layer in the area of the previous matte finish region on the test panel was visually inspected and was consistent with the surface gloss appearance of the clearcoat layer in the adjacent, unabraded region of the image. There were no visible scratches, an outline of the previously applied image could not be detected, and an orange peel surface texture was evident. The area of the test panel to which the image had been previously applied had been returned to its original glossy appearance.

### Example 2

A mask was prepared and applied to the clearcoat layer of the test panel according to “Mask Preparation and Application—Method B.” The procedure of Example 1 was then repeated except using the different mask and generating the image by damp sanding the test panel in the open area of the mask (i.e., the area inside the rectangular frame) for a total sanding time of approximately 5 seconds (rather than 10 seconds). A distinct matte finish region in the shape of a rectangle measuring 3 inches (7.6 cm) by 6 inches (15.2 cm) surrounded by a glossy region provided by the original clearcoat finish of the test panel was generated.

Following the procedure of Example 1, the matte finish region of the image was successfully removed and the surface gloss appearance of the clearcoat layer in this region was consistent with the surface gloss appearance of the clearcoat layer in the adjacent, unabraded region of the image. There were no visible scratches, an outline of the previously applied image could not be detected, and an orange peel surface texture was evident.

### Example 3

The procedure described in conjunction with Example 2 was repeated except that the image was generated by damp sanding the test panel in the open area of the mask by using a P1500 abrasive film disc rather than a P3000-3 abrasive foam disc. Removing the mask revealed a distinct matte finish region in the shape of a rectangle surrounded by a glossy region provided by the original clearcoat finish of the test panel.

The matte finish region of the previously applied image was successfully removed by following the motor vehicle paint finishing technique described in conjunction with Example 1 except that, prior to the compounding step, scratches were refined as follows. A P3000-6 abrasive foam disc was attached to a 6-inch interface pad and a 6-inch backup pad and assembled on to a random orbital sander, model “12,000 RPM, 8 MM, RANDOM ORBITAL SANDER” from 3M Company. The test panel was sprayed lightly with water and then damp sanded in five passes at a line pressure of 40 psi (275.8 kPa) for a total sanding time of approximately 45 seconds to refine the sanding scratches that were present in the matte finish region of the image.

The area of the test panel to which the image had been previously applied was visually inspected. The surface gloss appearance of the clearcoat layer was consistent with the adjacent, unabraded region of the previous image. There were no visible scratches, an outline of the previously applied image could not be detected, and the surface of the test panel was glossy, but with some loss of the orange peel texture.

### Example 4

The procedure described in conjunction with Example 3 was repeated except that the image was generated by damp sanding the test panel in the open area of the mask for 30 seconds rather than 5 seconds. Removing the mask revealed a distinct matte finish region in the shape of a rectangle surrounded by a glossy region provided by the original clearcoat finish of the test panel.

The conventional motor vehicle paint finishing technique described in conjunction with Example 3 was applied to the matte finish region and the test panel was visually inspected. A visible edge delineated a boundary between a recessed region and a raised region of the image. The surface gloss appearance of the clearcoat layer in the two regions was consistent. The clearcoat layer was glossy and there were no visible scratches; there was some loss of the orange peel surface texture.

### Example 5

The procedure described in conjunction with Example 4 was repeated except that the image was generated by damp sanding the test panel in the open area of the mask by using a P1200 abrasive film disc rather than a P1500 abrasive film disc. Removing the mask revealed a distinct matte finish region in the shape of a rectangle surrounded by a glossy region provided by the original clearcoat finish of the test panel.

The conventional motor vehicle paint finishing technique described in conjunction with Example 3 was applied to the matte finish region and the test panel was visually inspected. A visible edge delineated a boundary between a recessed region and a raised region of the image. The surface gloss appearance of the clearcoat layer in the two regions was consistent. The clearcoat layer was glossy and there were no visible scratches; there was some loss of the orange peel surface texture.

### Example 6

The procedure described in conjunction with Example 2 was repeated except that the test panel was supplemented with a paint protection film that was applied thereto before attaching the mask and generating the image. The test panel and both sides of a 12 inch by 19 inch (30.48 by 48.26 cm) section of paint protection film were sprayed with a 50% aqueous solution of isopropyl alcohol. The pressure-sensitive adhesive surface of the paint protection film was then applied to the clearcoat layer of the test panel; a squeegee was drawn over the paint protection film to remove air bubbles and to establish a firm bond to the test panel. The paint protection film was allowed to air dry.

Following the procedure described in conjunction with Example 2, the mask was assembled on the clearcoat layer of the paint protection film (instead of the test panel clearcoat layer) and an image was generated on the clearcoat layer of the paint protection film (instead of the test panel clearcoat layer). Removing the mask revealed a distinct matte finish region in the shape of a rectangle surrounded by a glossy region provided by the original clearcoat finish of the paint protection film. Following the procedure of Example 1, the matte finish region of the image was successfully removed and the surface gloss appearance of the clearcoat layer in this region was consistent with the surface gloss appearance of the clearcoat layer in the adjacent, unabraded region of the image. There were no visible scratches, an outline of the previously applied image could not be detected, and an orange peel surface texture was evident.

### Example 7

The procedure described in conjunction with Example 6 was repeated except that the image was generated by damp sanding the clearcoat layer of the paint protection film in the open area of the mask for 30 seconds rather than 5 seconds. Removing the mask revealed a distinct matte finish region in the shape of a rectangle surrounded by a glossy region provided by the original clearcoat finish of the paint protection film. Following the procedure of Example 1, the matte finish region of the image was successfully removed and the surface appearance of the clearcoat layer in this region was consistent with the surface gloss appearance of the clearcoat layer in the adjacent, unabraded region of the image. There were no visible scratches, an outline of the previously applied image could not be detected, and an orange peel surface texture was evident.

### Example 8

The procedure described in conjunction with Example 6 was repeated except that the image was generated by damp sanding the clearcoat layer of the paint protection film in the open area of the mask using a P1000 abrasive foam disc rather than a P3000-3 abrasive foam disc. Removing the mask revealed a distinct matte finish region in the shape of a rectangle surrounded by a glossy region provided by the original clearcoat finish of the paint protection film. Following the procedure of Example 3, the matte finish region of the previously applied image was successfully removed and this area of the paint protection film was visually inspected. There were no visible scratches, an outline of the previously applied image could not be detected, and an orange peel surface texture was evident. The surface gloss appearance of the clearcoat layer in the previous matte finish region was consistent with the surface gloss appearance of the clearcoat layer in the unabraded region.

### Example 9

A mask was prepared and applied to the clearcoat layer of the test panel according to “Mask Preparation and Application—Method B.” The procedure of Example 1 was then repeated except using the different mask, generating the image by damp sanding the test panel in the open area of the mask (i.e., the area inside the rectangular frame) using a P1000 abrasive foam disc (instead of a P-3000-3 abrasive foam disc), and conducting the damp sanding for a total sanding time of approximately 5 seconds (rather than 10 seconds). The mask was then removed to reveal a distinct region in the shape of a rectangle having a matte finish that was surrounded by a glossy region provided by the original clearcoat finish of the test panel.

The conventional motor vehicle paint finishing technique described in conjunction with Example 3 was applied to the matte finish region and the test panel was visually inspected. A visible edge delineated a boundary between a recessed region and a raised region of the image. The surface gloss appearance of the clearcoat layer in the two regions was consistent. The clearcoat layer was glossy and there were no visible scratches; there was some loss of the orange peel surface texture.

### Example 10

The procedure described in conjunction with Example 9 was repeated except that the image was generated by damp sanding the test panel in the open area of the mask for 30 seconds rather than 5 seconds. The mask was then removed to reveal a distinct region in the shape of a rectangle having a matte finish (corresponding to the recessed region of the recessed image) that was surrounded by a glossy region provided by the original clearcoat finish of the test panel.

The conventional motor vehicle paint finishing technique described in conjunction with Example 3 was applied to the matte finish region and the test panel was visually inspected. A visible edge delineated a boundary between a recessed region and a raised region of the image. The surface gloss appearance of the clearcoat layer in the two regions was consistent. The clearcoat layer was glossy and there were no visible scratches; there was a slight loss of the orange peel surface texture.

Although the invention has been described particularly in the context of imparting an image to the painted exterior surface of a motor vehicle, this is only by way of illustration and not limitation. The methods for imparting an image to a surface that are described herein and the kits that have been described for use in these methods may be readily applied to a wide variety of different surfaces so long as the surfaces are capable of being abraded in the presence of a mask to create an abraded region (for example, a matte finish region) corresponding to the open portion of the mask, and an adjacent, unabraded region corresponding to the masked portion of the mask, wherein the abraded region is visually distinct from the unabraded region. Other surfaces to which these methods could be applied include glass, bare metal, plastic, leather, fiberglass, gel-coats, marine surfaces, etc.

Similarly, the ability to treat a matte finish region and provide it with a surface finish that is consistent with the surface finish in an adjacent, unabraded region of an image has been described particularly in the context of the painted exterior surface of a motor vehicle. But this is only by way of illustration and not limitation and such methods may also be practiced on a diverse array of other surfaces such as glass, bare metal, plastic, leather, fiberglass, gel-coats, marine surfaces, etc.

Illustrative embodiments of the method for imparting an image to a surface and kits for use therefore are discussed and reference has been made to possible variations. These and other variations, combinations, and modifications will be apparent to those skilled in the art without departing from the scope of the invention, and it should be understood that this invention is not limited to the illustrative embodiments set forth herein. Rather, the invention is limited only by the claims provided below, and equivalents thereof.

What is claimed is:

1. A method for decorating a motor vehicle, method comprising:
applying a mask to an outer clearcoat layer of a painted exterior surface on the motor vehicle, the mask having a masked portion and an open portion that leaves part of the clearcoat layer exposed, wherein the masked portion and the open portion cooperate to define the image that is to be imparted to the surface, and wherein, prior to abrading the exposed part of the clearcoat layer, the exposed part of the clearcoat layer is free of defects;
abrading the exposed part of the clearcoat layer to provide the exposed part of the clearcoat layer with a matte finish; and
removing the mask to reveal an image having a matte finish region and an unabraded region;
leaving the image in place as a decoration for a period of time;
wherein the clearcoat layer in the matte finish region of the image is capable of being returned to its pre-abraded state by providing a surface gloss appearance that is consistent with the surface gloss appearance of the clearcoat layer in the unabraded region of the image and without painting the surface of the motor vehicle.

2. A method according to claim 1 wherein the unabraded region of the image is glossy.

3. A method according to claim 1 wherein there is a smooth transition between the matte finish region of the image and the unabraded region of the image.

4. A method according to claim 1 wherein the matte finish region of the image is recessed relative to the unabraded region of the image.

5. A method according to claim 1 wherein the abrading is continued for up to about 120 seconds per each 116 square centimeters being abraded.

6. A method according to claim 5 wherein the abrading is continued for up to about 30 seconds per each 116 square centimeters being abraded.

7. A method according to claim 6 wherein the abrading is continued for up to about 10 seconds per each 116 square centimeters being abraded.

8. A method according to claim 1 further comprising the step of, after leaving the image in place as a decoration for a period of time, treating the clearcoat layer in the matte finish region of the image to provide it with a surface appearance that is consistent with the surface appearance of the clearcoat layer in the unabraded region of the image and without painting the surface of the motor vehicle.

9. A method according to claim 8 wherein after treating the clearcoat layer in the matte finish region of the image, the clearcoat layer is glossy.

10. A method according to claim 8 wherein the unaided human eye is unable to detect scratches in the clearcoat layer where it was treated.

11. A method according to claim 8 wherein after treating the clearcoat layer in the matte finish region of the image, the unaided human eye is unable to detect an outline of the previously imparted image.

12. A method according to claim 8 wherein after treating the clearcoat layer in the matte finish region of the image, the clearcoat layer has an orange peel texture.

13. A method according to claim 8 wherein after treating the clearcoat layer in the matte finish region of the image, the image has a recessed region and a raised region.

14. A method according to claim 13 wherein the recessed region of the image and the raised region of the image are glossy.

15. A method according to claim 13 wherein the recessed region of the image and the raised region of the image have an orange peel texture.

16. A method according to claim 1 wherein the outer clearcoat layer to which the mask is applied is provided by a paint protection film or a vehicle wrapping film on the painted exterior surface.
